(19) United States
(12) Patent Application Publication
(10) Pub. No.: US 2002/0118146 A1
(43) Pub. Date: Aug. 29, 2002

(54) Display unit for a motor vehicle

(76) Inventors: Wolfgang Melcher, Stuttgart (DE); Mathias Sprengart, Neuhausen/Hamberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/076,615

(22) Filed: Feb. 19, 2002

(30) Foreign Application Priority Data
Feb. 17, 2001 (DE) 101 07 535.9

(51) Int. Cl. G09G 5/00

(52) U.S. Cl. 345/7

(57) ABSTRACT

A display unit in a dashboard of a vehicle is provided where the display unit is not visible to the viewing person in an inoperative position and, when its operation is started or for the purpose of being read, the display unit can be brought into an operative position by being swivelled by 180° out of its inoperative position.

### BACKGROUND OF THE INVENTION

This application claims the priority of 101 07 535.9, filed Feb. 17, 2001, the disclosure of which is expressly incorporated by reference herein.

The invention relates to a display unit which is arranged in the dashboard of a motor vehicle.

From German Patent Document DE 41 28 663 A1, a dashboard is known which has a video screen for displaying information and a keyboard for retrieving this information as well as for the input of data. In the normal driving operation, the video screen projects only by approximately one third out of the contour of the dashboard. If its entire display surface is required, it moves, in a motor-driven manner, completely out of the dashboard. The keyboard can, also by means of a motor, be moved out of a position lowered in the dashboard into a protruding operative position. For the moving-out with respect to its position, the known video screen is arranged such that it can be folded about a rearward swivelling axis out of the top side of the dashboard. In addition, the known video screen can be swivelled about a vertical axis in order to be arranged from a position directed toward the driver into a position directed toward the front passenger.

An object of the present invention is to provide an improved display unit of the above-noted type. This object is achieved according to preferred embodiments of the present invention by providing a display unit for a motor vehicle, which is arranged in a lowerable manner in the vehicle dashboard, a rear side of the display unit, which is visible in a lowered inoperative condition, fitting into a contour of the dashboard, the display unit being swivellable by 180° along one of its axes for moving to an operational position.

The display unit according to the invention has the advantage that, in its inoperative position, it fits seamlessly into the contour of the dashboard and does not interfere with the harmonious overall impression of the dashboard. Furthermore, as a result of the central arrangement, the display unit can be read in the operative position by the driver as well as by the front passenger without any additional swivelling.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of an arrangement of the display unit on a vehicle dashboard, constructed according to a preferred embodiment of the invention;

FIG. 2 is a longitudinal sectional view of the display unit of FIG. 1, shown in an operative position;

FIG. 3 is a cross-sectional view of the display unit of FIG. 1, shown in the operative position;

FIG. 4 is a cross-sectional view of the display unit of FIG. 1 shown swivelled by 45° out of the operative position; and

FIG. 5 is a cross-sectional view of the display unit of FIG. 1, shown in an inoperative position.

### DETAILED DESCRIPTION OF THE DRAWINGS

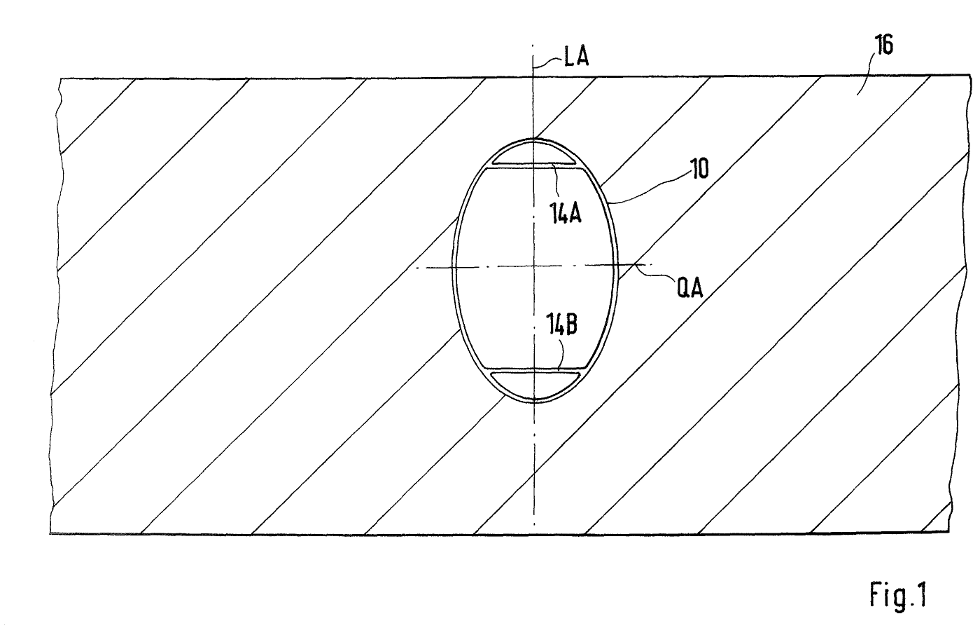

FIG. 1 illustrates a display unit 10 in an inoperative position, in which case a dashboard 16 is indicated only schematically as a hatched surface. The display unit 10 is embedded in the dashboard 16. The display unit has an essentially oval basic shape and, in the inoperative position, fits into the flat contour of the dashboard. This FIG. 1 shows the longitudinal axis LA and the transverse axis QA which form the sectional axis for the longitudinal and cross section of the representations in the additional figures.

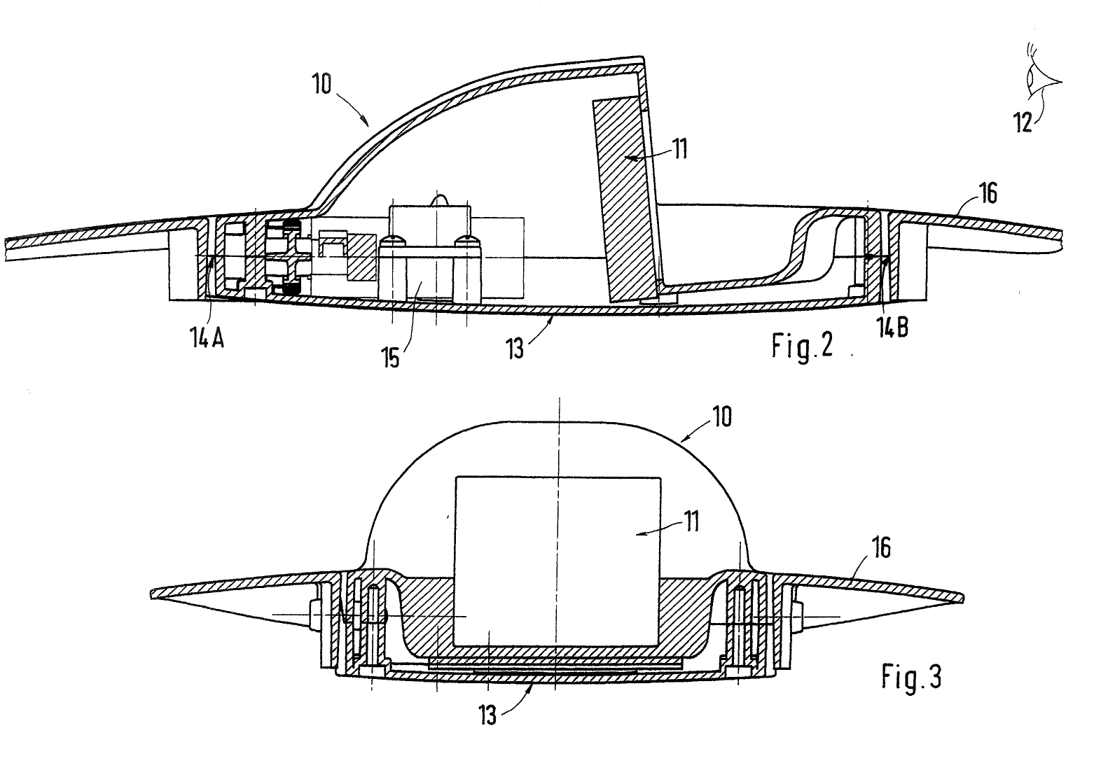

FIG. 2 is a partially sectional view of the display unit 10, the section extending along the longitudinal axis LA. The display unit 10 is in the operative position so that the display 11 can be read by a viewing person 12 who is indicated only symbolically. In the operative position, the rear side 13 of the display unit 10 faces away from the viewer. On the whole, the display unit 10 is rotatably disposed on its longitudinal-side ends at points 14a and 14b, so that the swivelling can take place by 180° from the operative position into the inoperative position and vice versa. In the interior of the display unit, for example, a compass 15 can be arranged so that, by way of a corresponding detection, the corresponding cardinal point into which the vehicle is moving can be indicated in the compass. Another possibility is the display of the side tilt of the vehicle which is clearly important in cross-country driving.

FIG. 3 is a cross-sectional view of the display unit 10, the display unit being illustrated from the direction seen by the viewer. Here also, the display for displaying the various information has the reference number 11. The rear side 13 is situated in this case on the side of the display unit facing away from the viewing person in the dashboard. In all figures, the dashboard has the reference number 16.

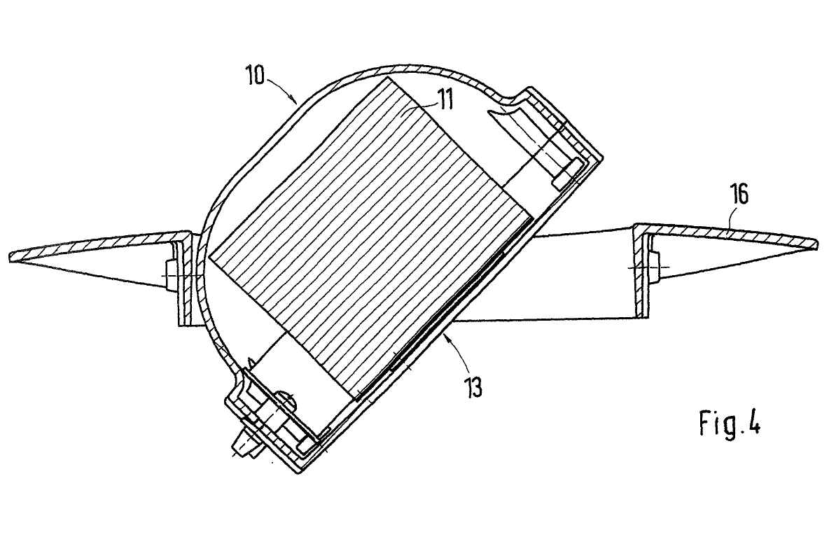

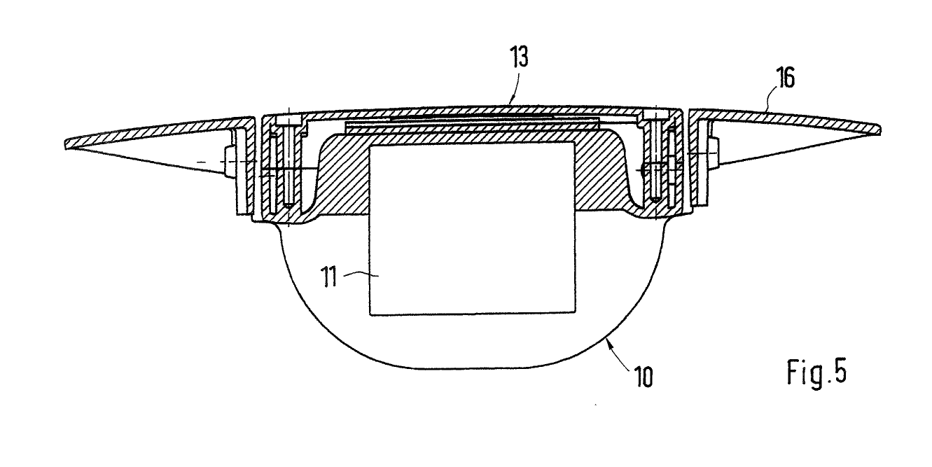

FIG. 4 is a cross-sectional view of the display unit, the display unit being swivelled out of its operative position by 45°. It is clearly illustrated here that the rear side 13 of the display unit 10 has a curvature which, in the inoperative position of the display unit 10 places itself in a form-locking flush manner in the contour of the dashboard, as shown in FIG. 5.

FIG. 5 shows the display unit 10 in the inoperative position. This figure is a good illustration of the fact that the rear side of the display unit fits harmoniously into the curvature of the dashboard.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Display unit for a motor vehicle, which is arranged in a lowerable manner in the vehicle dashboard, a rear side of the display unit, which is visible in a lowered inoperative condition fitting into a contour of the dashboard, the display unit being swivellable by 180° along one of its axes for moving to an operational position.

2. Display unit according to claim 1,
wherein the swivelling movement is accompanied by a lifting and subsequent lowering movement of the swivel display.

3. Display unit according to claim 1,
wherein in the operative position of the display unit, the display is essentially perpendicular to the driver's viewing direction.

4. Display unit according to claim 1,
wherein the display unit has an essentially oval shape in a top view of its display side.

5. Display unit according to claim 1,
wherein the contour of a section of the display unit, with respect to the longitudinal axis, rises from the side facing away from the driver to the center of the longitudinal axis and then comprises a video screen.

6. Display unit according to claim 2,
wherein the contour of a section of the display unit, with respect to the longitudinal axis, rises from the side facing away from the driver to the center of the longitudinal axis and then comprises a video screen.

7. Display unit according to claim 3,
wherein the contour of a section of the display unit, with respect to the longitudinal axis, rises from the side facing away from the driver to the center of the longitudinal axis and then comprises a video screen.

8. Display unit according to claim 4,
wherein the contour of a section of the display unit, with respect to the longitudinal axis, rises from the side facing away from the driver to the center of the longitudinal axis and then comprises a video screen.

9. A vehicle dashboard assembly comprising;
a dashboard panel having a recess, and
a display unit mounted in the recess to be movable by 180° about a pivot axis between an operational display position protruding out of said panel toward a facing passenger space and a non-operational position.

10. An assembly according to claim 9,
wherein said display unit includes a front side which exhibits an oval shaped housing section supporting a display surface.

11. An assembly according to claim 10,
wherein said front side faces the passenger space when said display unit is in the operational display position.

12. An assembly according to claim 9,
wherein said display unit includes a rear side which is configured to form a conformed continuation of adjacent dashboard panel surfaces when the display unit is in said non-operational position.

13. An assembly according to claim 11,
wherein said display unit includes a rear side which is configured to form a conformed continuation of adjacent dashboard panel surfaces when the display unit is in said non-operational position.
